(19) United States
(12) Patent Application Publication
(10) Pub. No.: US 2002/0143735 A1
(43) Pub. Date: Oct. 3, 2002

(54) User scope-based data organization system

(76) Inventors: Akin Ayi, Nashua, NH (US); Pete Cruz, Derry, NH (US); Roger Dev, Durham, NH (US); Eric Rustici, Londonderry, NH (US); Vick Vaishnavi, Danville, NH (US); Prashant Darisi, Nashua, NH (US)

Correspondence Address: NUTTER MCCLENNEN & FISH LLP, WORLD TRADE CENTER WEST, 155 SEAPORT BOULEVARD, BOSTON, MA, 02110-2604, US

(21) Appl. No.: 09/943,410

(22) Filed: Aug. 30, 2001

Related U.S. Application Data
(63) Continuation-in-part of application No. 09/822,769, filed on Mar. 30, 2001.

(51) Int. Cl. G06F 7/00

(52) U.S. Cl. 707/1

(57) ABSTRACT

The present invention provides methods and system for organizing a dataset in a database by marking the dataset by a plurality of labels generated based on a pre-define policy. The policy determines the data scope accessible to each label. A user of the database can access the data within the scopes of one or more labels based on its role and privileges granted thereto by, for example, a system administrator. Moreover, a variety of shaping transformations can be applied to the tagged dataset to create a derived dataset that is suitable for the informational needs of the user. The derived dataset can be formatted to render it compatible for viewing via a selected presentation engine, such as a web browser.

### RELATED APPLICATIONS

This application is a continuation-in-part of U.S. patent application Ser. No. 09/822,769, entitled “User Scope-based data organization system”, herein incorporated by reference.

### BACKGROUND OF THE INVENTION

The present invention relates generally to providing methods and system for organizing data in a database, and more particularly, for organizing the data in accordance with the informational needs of users of the database.

The management of large complex systems such as computer networks, power plants, transportation systems and military operations requires cooperation of many individuals acting in various roles and having responsibility for various subsets of the system. Each individual needs access to certain aspects of information about the system in order to be able to discharge his/her responsibility. System information is typically collected and maintained by various management information systems. The collected system data, however, is usually too large and too complex to be effectively utilized by an individual. Further, an individual may need access to only a subset of the entire data. In addition, the format of the collected raw data is typically not amenable to effective presentation to a user.

Accordingly, a need exists for providing methods and system for organizing data such that it can be efficiently utilized by individuals having different informational needs.

Further, a need exists for presenting information to such individuals in a manner that allows effective use of the information.

### SUMMARY OF THE INVENTION

The present invention provides methods and system for organizing information in a dataset contained, for example, in a database system. In one aspect, a method of the invention calls for defining a set of rules that establish a policy, and generating one or more labels based on the defined policy for marking, e.g., tagging, the dataset. The defined policy determines the data scope that is accessible to each label.

The policy can be defined based on various criteria that can include, but are not limited to, structure of an organization, geography, location of selected entities, names of selected entities, or interrelationships among selected entities. For example, in the network management domain, a policy can define a range of IP (internet protocol) addresses. Alternatively, a policy may define the telecommunications switches of a telephone service provider which are located within a particular locality, e.g., state, county, city.

In some embodiments, the dataset can include a plurality of fields and the rules of a policy can be defined as expressions, e.g., regular, Boolean, operating on selected fields of the dataset. Further, a policy may require matching a pre-defined pattern, e.g., address, location, or name, with selected fields of the dataset. Alternatively, a policy may require a calculation to determine whether a data element, e.g., field, is within the scope of the policy. For example, in the network management domain, a network path calculation may be utilized to determine which network elements support a particular application, e.g., electronic mail. The method of the invention also allows exceptions to general rules of policy to be defined to attain fine grain control of the dataset.

In one aspect, the labels generated for tagging the dataset are interrelated according to a selected topology. Such a topology can assume, for example, a distributed configuration or a hierarchy, such as a tree structure. Each label in a hierarchy can provide an entry point into the hierarchy, and a role of a user of the database can determine its entry point into the hierarchy. In other words, a role of the user can determine the labels, and consequently the data associated with those labels, to which the user has access. In some embodiments, a combination of a user's role and permission granted to the user determine the labels and/or the portions of data associated with the labels that are available to the user.

In a related aspect, the data scope of a label can be independent of the scopes of the other labels. Further, the data scope of a label within a hierarchy can be independent of the hierarchy and be only related to the role of a user having access to that label. For example, the data scope of a label in a label hierarchy can be more extensive than the data scope of another label that is higher in the hierarchy.

In another aspect, the method of the invention calls for transforming the data within the data scope of a label accessible to a user to create a derived data set, e.g., a subset of the data, that is suited to the informational needs of that user. Such a transformation can include, but is not limited to, summarization, statistical analysis, filtering, projection, or any other manipulation that transforms the information into a useful form for a targeted role, i.e., for a user having a particular role. For example, a temporal transformation can aggregate selected fields within a data scope of a label over a specified time period. The transformation preferably preserves the association of the derived data set with the label from which it was derived. This advantageously allows performing efficiently any number of iterative transformations.

In a related aspect, the derived data set can be formatted to augment it with information needed for a selected presentation format. A formatting transformation does not alter the information content of the derived data set, but adds information needed by various presentation engines for presenting, e.g., displaying, the data to a user. A presentation format can include, for example, hypertext mark-up language (HTML), extended mark-up language (XML), portable document format (PDF), comma-separated values (CSV), or relational database management system (RDBMS).

In still another aspect, the invention provides a method for shaping information in a dataset by selecting one or more fields in the dataset, and transforming the selected fields based on a pre-defined set of one or more operations to generate an intermediate dataset. The fields can be selected, for example, by applying a filter to the dataset. The method further calls for generating a derived dataset from the intermediate dataset by summarizing the information contained in the transformed fields and/or re-ordering the transformed fields. The derived dataset can also be obtained by expanding the information contained in the transformed fields.

Various transformations can be applied to the selected fields. For example, various mathematical operations, such as multiplication and addition, can be applied to these fields. Further, various statistical functions can be applied to these fields to obtain, for example, the mean, and/or median values of the fields. Alternatively, a variety of string functions, such as, concatenation, slicing and truncation, can be applied to these fields to effectuate various textual manipulations, e.g., generating a list from a string of characters.

As discussed above, the derived dataset can be formatted in accordance with any selected presentation format, e.g., HMTL, XML, to generate a report. In a related aspect, the report can be created automatically at pre-defined time intervals, e.g., weekly, bi-weekly, monthly, etc. Further, a user can be alerted if the values of one or more selected fields exceed or fall below a pre-defined threshold.

The methods of the invention can find a variety of applications. In particular, they are well suited for organizing data received by a network management system. In such a case, a policy related to the management of the network can be formulated, and the received data can be labeled based on the formulated policy in accord with the teachings of the invention. The policy can relate to, for example, the switches of an internet service provider (ISP) which support a particular customer of the ISP.

In a related aspect, a system for implementing a method of the invention can include a scope transform module that is in communication with a database. The scope transform module receives raw data from the database and adds labels to, i.e., marks, at least a portion of the raw data based on a pre-defined policy. The system can also include a shaping transform module that receives the labeled data and transforms at least a portion thereof to create a derived dataset that conforms to the informational needs of a user.

A format transform module receives the derived dataset and augments it with information needed for a selected presentation format, such as HTML, XML, PDF. A variety of presentation engines can be utilized to present the formatted data to a user. For example, one embodiment employs a web browser to present the derived dataset, which has been formatted in a web presentation format, e.g., HTML.

In a related aspect, a system of the invention includes a graphical user interface (GUI) that allows a user to interact with various modules of the system, such as, the scope transform module and/or the shaping transform module. The GUI is preferably menu-driven and includes a menu hierarchy that presents a list of reports from which a user can select one or more reports to be generated.

The user can utilize the graphical user interface to transmit instructions to an exchange editor which can in turn communicate with the transform module for selective formatting of the derived dataset. Alternatively, the GUI can be employed to communicate with the shaping transform module via a transformation editor and/or communicate with the scope transform module via a collection editor.

Illustrative embodiments of the invention will be described below with reference to the following drawings.

### BRIEF DESCRIPTION OF THE DRAWINGS

FIG. 1 is a flow chart depicting various steps of an exemplary embodiment of a method according to the invention for organizing data in a database,

FIG. 2 illustrates a sample policy defined in accord with the teachings of the invention,

FIG. 3 illustrates a sample label file created in accord with the teachings of the invention,

FIG. 4 schematically depicts an exemplary label hierarchy generated in accord with the teachings of the invention,

FIG. 5 is an exemplary user access list in accord with the teachings of the invention,

FIG. 6 is a diagram depicting various transformations applied to raw data present in a dataset in an exemplary embodiment of the invention,

FIG. 7 illustrates a sample policy file in accord with the teachings of the invention,

FIG. 8 is a diagram depicting an exemplary system for implementing a method for organizing data in accord with the teachings of the invention,

FIG. 9 is a flow chart depicting various steps that an exemplary shaping transform module of a system of the invention can perform for creating a derived dataset,

FIG. 10 is a flow chart depicting various steps in an exemplary embodiment of the invention for applying shaping transformations to a dataset,

FIG. 11A presents a list of exemplary data elements which can be included in a data set to which shaping transformations according to the teachings of the invention can be applied,

FIG. 11B presents a number of data elements selected from the list of FIG. 11A,

FIG. 12 presents an exemplary input data set to which transformations according to the teachings of the invention can be applied,

FIG. 13 presents a filtered dataset obtained by applying a selected filter to the data elements of FIG. 12,

FIG. 14 presents an derived data set obtained by applying selected mathematical operations to the dataset of FIG. 13,

FIG. 15 presents a derived data set obtained by applying a summarizing transformation to the data set of FIG. 14,

FIG. 16 presents another derived dataset obtained by an expanding the data set of FIG. 15 with respect to location,

FIG. 17 presents another derived dataset obtained by adding new fields to the dataset of FIG. 16,

FIG. 18 is another derived dataset obtained by applying custom-defined transformations to the dataset of FIG. 15,

FIG. 19 is a diagram schematically depicting an exemplary system architecture for implementing data collection, transformation, and formatting in accord with the teachings of the invention, and

FIG. 20 presents a partial list of data formatting options provided to a user by a system of the invention.

### DETAILED DESCRIPTION

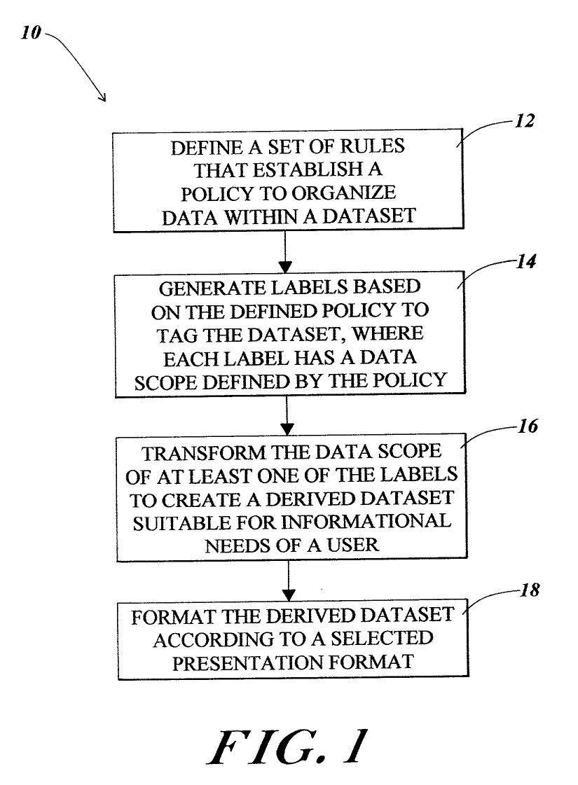

The present invention provides methods and system for organizing data in a database. FIG. 1 illustrates a flow chart 10 which depicts various steps for implementing an exemplary embodiment of the method of the invention. In step 12, a set of rules are defined for establishing a policy. A policy can be defined based on a variety of criteria which include, but are not limited to, the structure of an organization, geography, the location of selected entities, e.g., devices in a network of computers, the names of selected entities, and/or interrelationships among selected entities. As discussed in more detail below, a policy can be defined based on pattern matching, where the pattern can be, for example, a particular range, a regular expression, or a wild card. Alternatively, a calculation on a set of dependencies of a data element, e.g., a data field, can be performed to determine whether that data element is within a scope of a particular policy. For example, in the network management domain, a network path calculation can be performed to determine which network elements are within the scope of devices supporting a particular application.

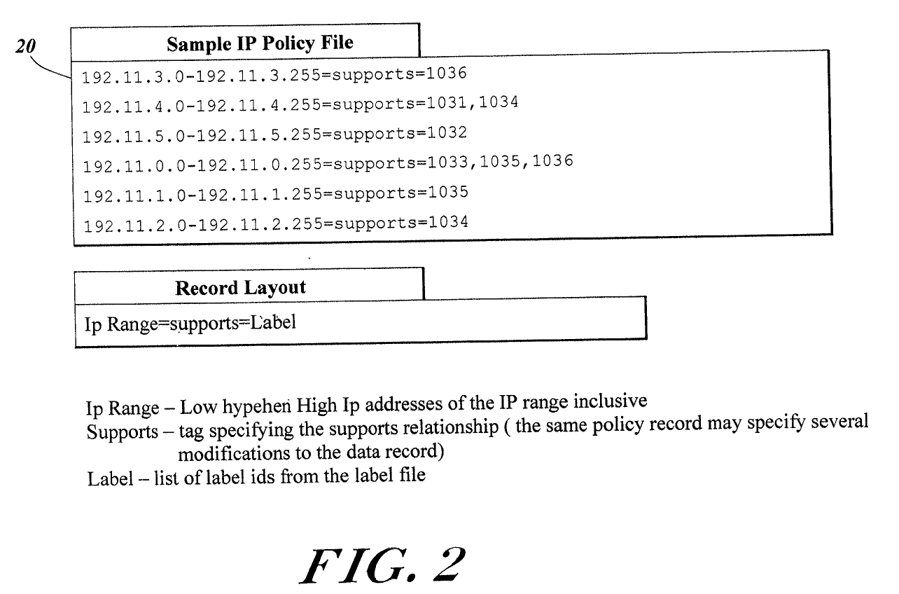

By way of example, FIG. 2 depicts a sample policy file 20 containing an illustrative policy defined in accord with the teachings of the invention in the network management domain. This policy defines a set of ranges of IP (internet protocol) addresses, and farther provides an association between each IP address range and the identification field of a label to be defined.

Referring again to FIG. 1, in step 14, a plurality of labels are generated based on the defined policy. The labels are utilized to mark, e.g., tag, the data set. Each label has a scope that is defined by the policy. The scope of a label, as used herein, refers to the data, e.g., the data files, that are accessible to that label. In other words, those data files that have been designated to be associated with a particular label are considered as belonging to, or forming, the scope of that label.

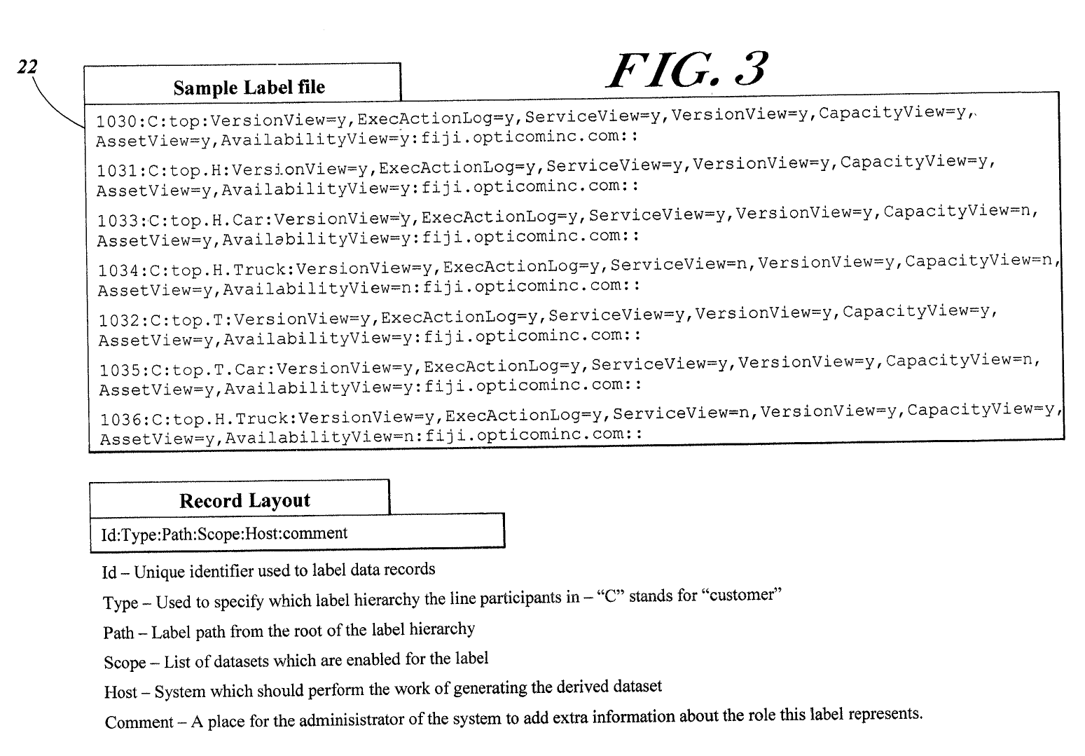

FIG. 3 illustrates a sample label file 22 created in accord with the teachings of the invention based on a pre-defined policy. The sample label file 22 includes a plurality of labels, each of which is identified by an identification (Id) number (in a range of 1030 to 1036). Each label has a scope, i.e., a list of data files enabled for that label, that is determined by parsing a policy file, e.g., the sample policy file 20. For example, the sample policy file 20 indicates that the scope of a label having an identification number 1036 includes data relating to IP addresses ranging from 192.11.3.0 to 192.11.3.255 and also ranging from 192.11.0.0 to 192.11.0.255. Thus, data corresponding to entities, e.g., devices, having IP addresses in these two ranges forms the scope of a label having the Id number 1036.

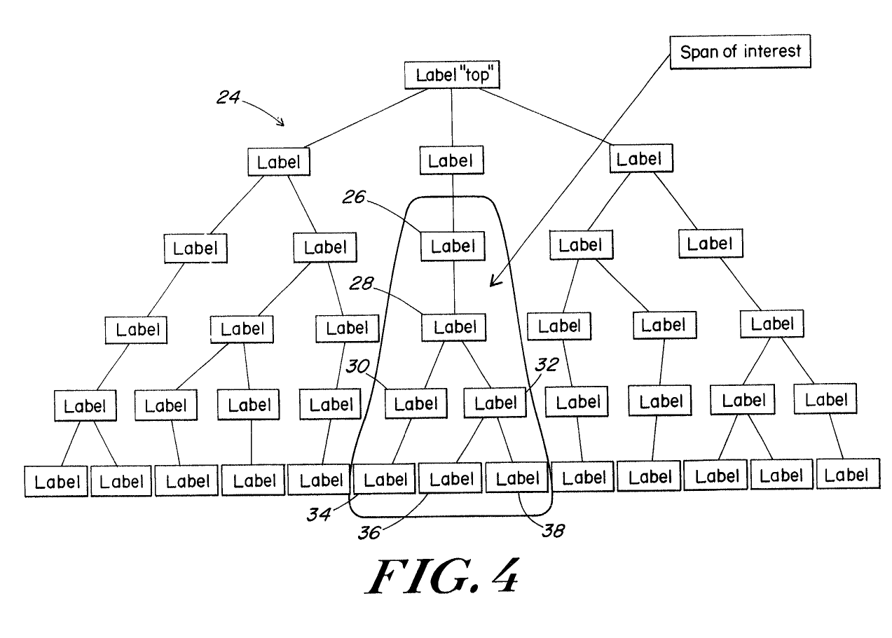

The labels generated by a method of the invention can be interrelated according to a selected topology. Such a topology can be, for example, a distributed configuration, or it can form a hierarchy, such as a tree structure. For example, FIG. 4 illustrates a label hierarchy 24 created in accord with the teachings of the invention which includes a root label, herein designated as Label “top”, from which a plurality of labels emanate. The inclusion of the label “top” ensures that the complete dataset is available for presentation. Each label has a selected data scope determined by at least one policy, as described above.

Referring again to FIG. 3, the sample label file 22 presents an example of a label hierarchy. In particular, the label 1030 is the root label that spawns the other labels. Further, labels H.Car and H.Truck are both derived from the label H (designating an automobile manufacturing company), and labels T.Car and T.Truck are both derived from the label T (designating another automobile manufacturing company). Although the labels T and H belong to two different branches of the label tree, they may nevertheless share some common data files within their respective scopes. For example, label file 22 in FIG. 3 shows that some data files, e.g., VersionView, ExecActionLog, as accessible to both H and T labels.

Referring again to FIG. 4, a union of a plurality of selected labels, i.e., a union of the data scopes of selected labels, provides a span of interest. In this example, a union of the data associated with labels 26-38 forms the span of interest.

In general, a user is allowed to access information organized in accord with the teachings of the invention based on a set of pre-defined privileges granted thereto. In particular, a role assigned to a user determines the data within the scope of one or more labels that are available to the user. When the labels form a hierarchy, the role of the user determines its entry point into that hierarchy. In some embodiments of the invention, a user who can enter a label hierarchy at a principal label can also access data within the scopes of labels below the principal label. For example, with reference to FIG. 4, if a user has permission to enter the label hierarchy 24 at the label 26, it also has permission to enter the label hierarchy at label 28. This allows a user to assume different roles and view the information from different perspectives.

In addition, some embodiments of the invention provide a second level of permission that specifies the data files within the scope of a label that a user can access. For example, a user whose role allows it to access the label 28 may not have permission to view every data file within the scope of this label. Rather, such a user may have access to a subset of the data within the scope of the label 28.

System administrators typically have special privileges. These privileges may include, for example, the privilege to create other users and to define policies which determine the scope of labels. The privileges of an administrator may also be scoped by a role hierarchy. For example, an administrator may be able to provide a user with privileges which are similar to or less than those of the administrator, but may not be able to allow a user to assume more roles than the administrator itself can assume.

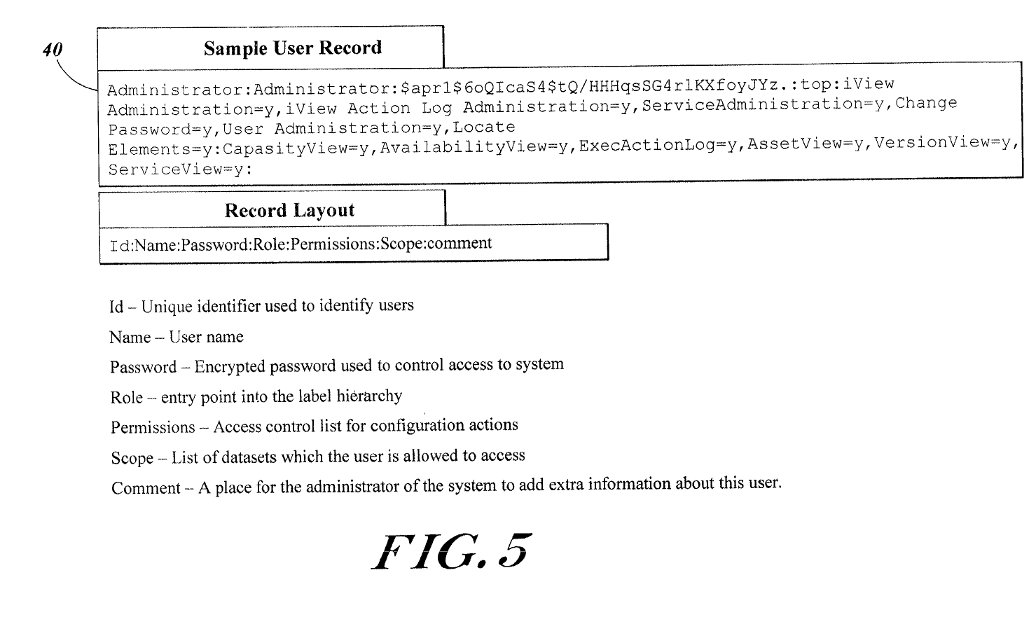

In some embodiments, the information regarding the privileges granted to a user is stored in a user access list. FIG. 5 illustrates an exemplary user access list 40 that includes an Id field containing a unique identifier for identifying a user, a Name field that includes the name of the user, a Password field that controls access to the database, and a Role field that indicates the entry point at which the user can access a label hierarchy. The exemplary user access list 40 also provides information regarding permissions granted to a user, including the scope of datasets that the user is allowed to access.

In a label hierarchy, the data scope of one label may be independent from that of another label. Further, the data scope of a label can be independent of the label hierarchy. For example, with reference to FIG. 4, although label 28 is further down in the hierarchical tree structure than label 26, it may have a larger scope than that of label 28. That is, label 28 can provide access to a larger set of data files than label 26. The advantages provided by such a decoupling of the label scope from label hierarchy can be perhaps better understood by considering an example. A user whose principal entry point into the label hierarchy is the label 28 may be the manager of a division of an automobile manufacturing company. Hence, the data scope of label 28 is commensurate with the informational needs of the division manager. For example, the division manager may need access to information regarding the number of cars sold within a particular time span. This information can be found within the data scope of the label 28.

Another user whose principal entry point into the label hierarchy is the label 26 may be the marketing manager of this company. The marketing manager may need more detailed information regarding sales statistics than the division manager. For example, the marketing manager may need to know not only the number of cars sold within a particular time span, but also the colors of the cars sold. Thus, the data scope of the label 28, i.e., the data to which label 28 has access, may be more extensive than that of the label 26. That is, although the label 28 is lower in the hierarchical tree than the label 26, it nevertheless provides access to a more extensive set of data files than the label 26. The division manager, however, can assume the role of the marketing manager, if needed, to enter the label hierarchy at label 28 to obtain access to more detailed information regarding sales.

Referring again to the flow chart 10 of FIG. 1, subsequent to generating labels, the data scope associated with a selected label can be transformed, in step 16, to create a derived data set which is suitable for the informational needs of a user having access to that label. For example, with reference to the sample label file 22 of FIG. 3, such a transformation can be utilized to derive information about the number of cars sold during a particular time span from the data contained within the scope of the label H.Car. The transformation preferably preserves the association of the derived data set with the label from which the derived data set is obtained. For example, in this case, the derived data set containing information regarding the number of cars sold remains within the scope of the label H.Car.

A number of different transformations, also referred to herein as shaping transformations, can be performed on the data within the scope of a label to create a variety of derived data sets. Further, a variety of algorithms and calculations can be utilized to implement such transformations so long as they preserve any scoping labels which appear in the data records. A simple type of transformation is summarizing a particular data set along a selected dimension, e.g., geography, time. For example, a temporal transformation can summarize the data over a specified time period, e.g., number of switch failures in a telecommunications system over a period of a month obtained by summarizing the daily data regarding such failures.

The method of the invention further allows presenting the derived data set to a user in any format that is preferable to that user. In particular, with reference to FIG. 1, in step 18, the derived dataset is formatted to a format needed by a selected presentation engine. The presentation formats that can be utilized for formatting the derived data set can include, but are not limited to, HTML, XML, PDF, RDBMS, and CSV.

The method of the invention for organizing data in a database provides distinct advantages. In particular, employing a labeling scheme based on a pre-defined policy in conjunction with shaping transformations provides a flexible information system that can be readily tailored to the needs of various organizations. Further, providing a hierarchical role tree through which users can be granted access to multiple scopes of data ameliorates the administrative burden of aligning an individual user's view of the information with the user's responsibilities within the organization. Further, the use of record labeling to indicate data scope, and ensuring that shaping transformations preserve such a labeling scheme, allow providing a customizable information system with minimal complexity.

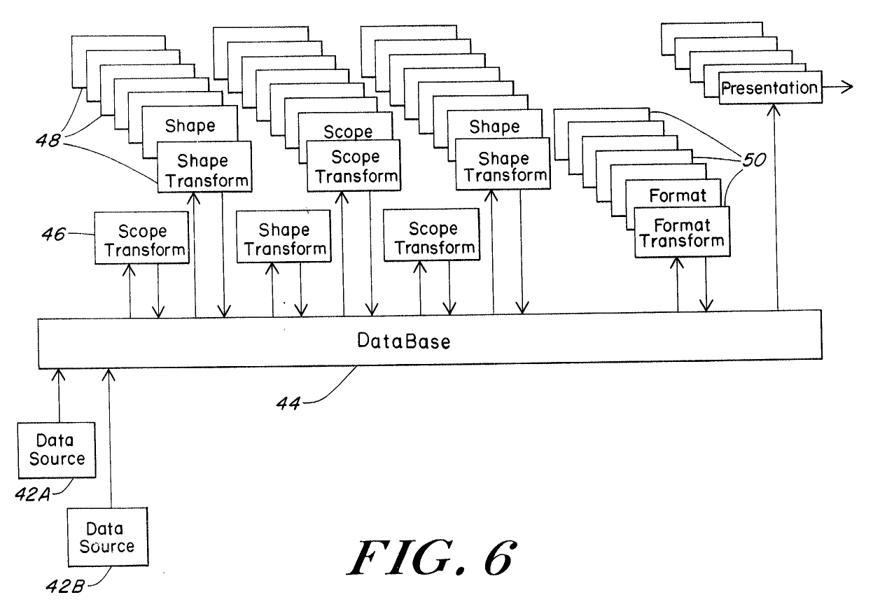

The methods and system of the invention can be utilized in a variety of different applications. For example, in the network management domain, methods and system according to the invention can be utilized to organize data corresponding to performance of a network. With reference to FIG. 6, a variety of data sources, such as sources 42A and 42B, populate a database 44 with raw data corresponding to network related data which can include, e.g., device information such as name, location, IP address, configuration settings, fault settings, performance parameters, security parameters, bandwidth. Other network related information can include, e.g., topology mapping data, system capacity data, server discovery data, etc.

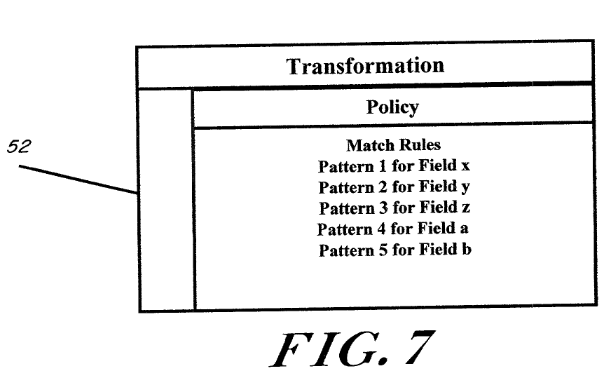

A scoping transformation 46, based on a pre-defined policy, is performed on the raw data to label the data in a manner described above. As shown in FIG. 7, a policy can be based on matching pre-defined patterns with selected fields of the data. In a network-related policy, a defined pattern can be, for example, a range of IP addresses of network devices, e.g., routers, or alternatively, it can be devices which are located within a particular geographical range.

As discussed above, a user can access the data within the scope of one or more labels based on its pre-defined roles. Referring again to FIG. 6, a variety of shaping transformations can be performed on the data within the scope of a label to which the user has access to create derived data sets that are suited to the different informational needs of that user. That is, a derived data set includes “customized” data for a particular need of a user. Such a derived data set can include, for example, a summary of data regarding traffic congestion and performance data for network devices having IP addresses that lie within a specified range. In addition, the shaping transformation can include statistical analysis, filtering, or any other manipulation of the data that renders it suitable for the needs of a user.

Multiple iterations of scoping and shaping transformations can be performed on a set of data. That is, a derived dataset generated by a shaping transformation can be utilized as an input for another shaping transformation or another scoping transformation. Further, a variety of formatting transformations 50 can be applied to the transformed data to prepare it for presentation via selected presentation engines.

FIG. 8 is a diagram that schematically depicts an exemplary system 54 for implementing a method for organizing data in a database in accord with the teachings of the invention. The exemplary system 54 includes a scope transform module 56 that is in communication with a database 58 which stores raw data. The scope transform module 56 generates labels based on a pre-defined policy to mark, i.e., tag, at least a portion of the raw data to create a tagged dataset 60.

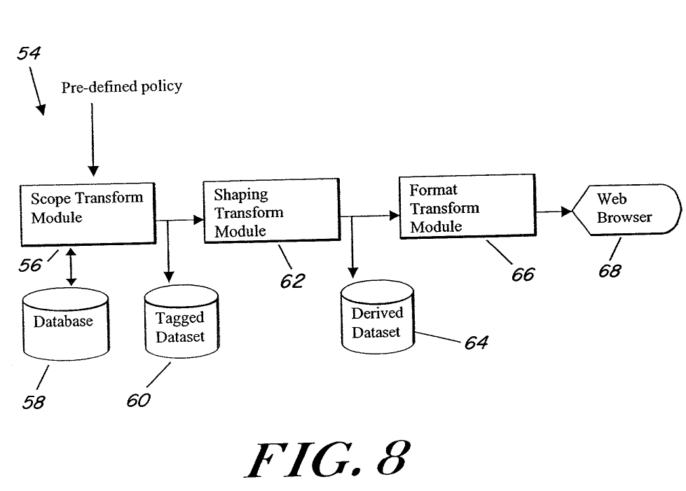

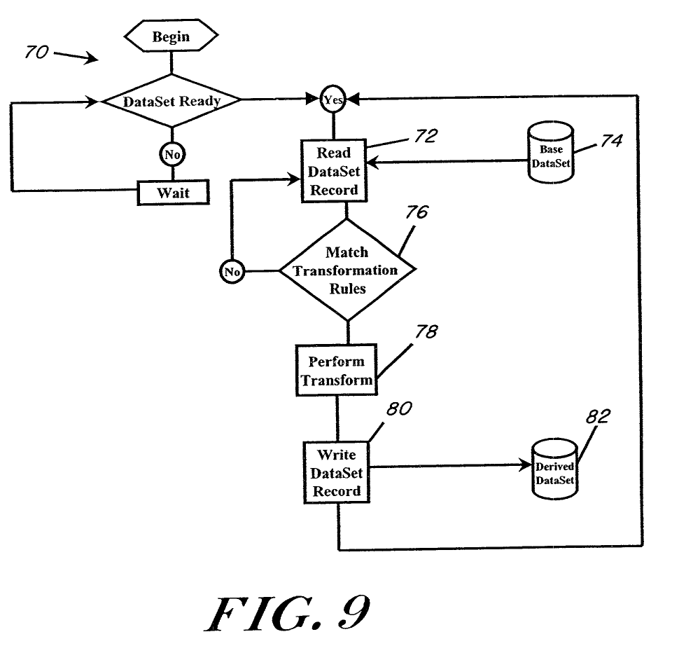

A shaping transform module 62 receives the tagged data and generates a derived dataset 64 therefrom. FIG. 9 provides a flow chart 70 that schematically illustrates the operation of the exemplary transform module 62 of FIG. 8. In particular, in step 72, data is read, for example, record by record from a dataset 74. In step 76, a comparison is made between the data and a set of pre-defined transformation rules. If the comparison indicates that a match exists, i.e., the data needs to be transformed, the transformation process continues, as described below. Otherwise, another data record is read and the comparison step 76 is repeated. In step 78, a transformation is performed on those records that match the pre-defined transformation rules. In step 80, the output of the transformation is written to a derived dataset 82. It is this derived dataset 82 that is then formatted and eventually presented to an authorized user.

Referring again to FIG. 8, the exemplary system 54 further includes a format transform module 66 that can apply one or more formatting transformations to the derived data set to augment it with requisite information for presentation to a user. A number of presentation engines can be utilized to present the formatted information to a user. In this example, a web browser 68 presents the data in a web format, e.g., HTML, to a user.

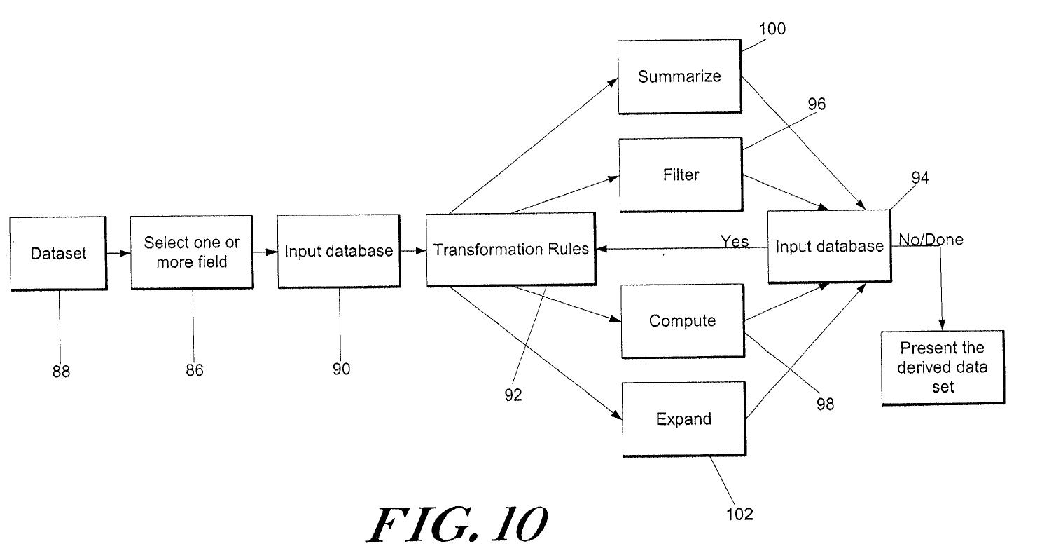

As discussed above, the invention allows applying a variety of shaping transformations to a dataset in order to generate a derived dataset and a variety of reports based on the information contained in the derived dataset. One aspect of the invention relates to providing methods and system for implementing such shaping transformations. FIG. 10 is a flow chart 84 that depicts various steps in an exemplary embodiment of the invention for applying shaping transformations to a dataset, e.g., a tagged dataset obtained through a labeling process described above.

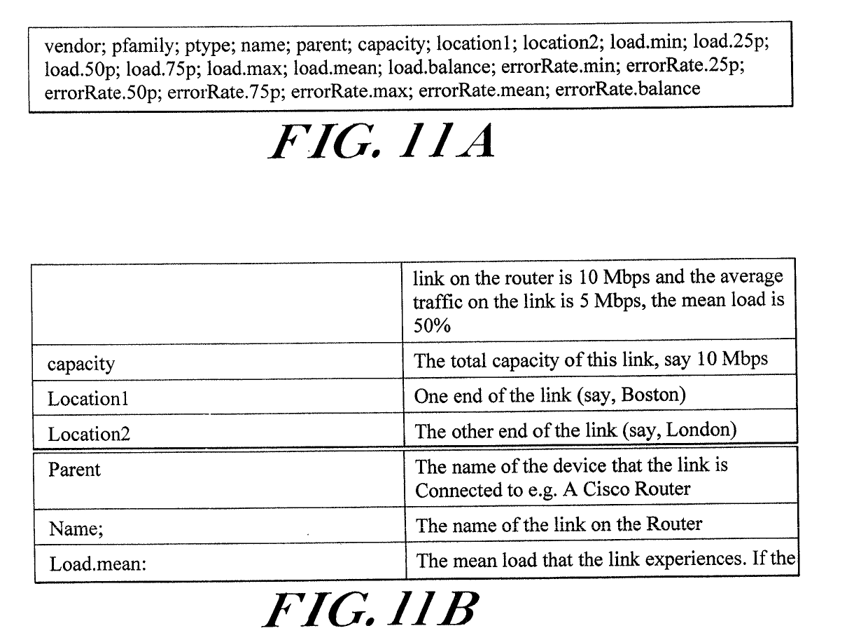

With reference to the flowchart 84, in step 86, one or more fields or records of a base dataset 88 are selected to generate an input dataset 90 for subsequent processing. For example, a user, such as an ISP, may be interested in monitoring the volume of network traffic carried on its transmission links supported by various devices, such as routers, switches, or hubs. As an initial step, the method of invention allows such a user to choose a base dataset that contains the requisite information for performing an analysis to determine the traffic volume. FIG. 11A provides a list of exemplary data elements that such a base dataset, herein referred to as Capacity/Link, can contain. The user can select those data elements that are relevant to the analysis of the traffic volume. By way of example, FIG. 11B shows that the user can select data elements relating to the name of a device to which a particular link is connected, the name of the link, the average traffic load carried by the link, the total capacity of the link, and the geographical locations at the two ends of the link. FIG. 12 illustrates an exemplary input data set 90a that is obtained based on the above selection of the data elements.

Referring again to FIG. 10, in step 92, one or more transformations can be applied to the dataset 90 to generate a derived dataset 94, as described in more detail below. A filter 96 represents one such transformation that can be applied to the input dataset 90 to obtain a derived dataset 94 which is more suited to particular informational needs of the user. Such a filter can effect the selection of data fields based on a variety of criteria. For example, the value of a data field can be matched with a pre-defined value and/or range. Alternatively, the name of a data field can be matched with a pre-defined name.

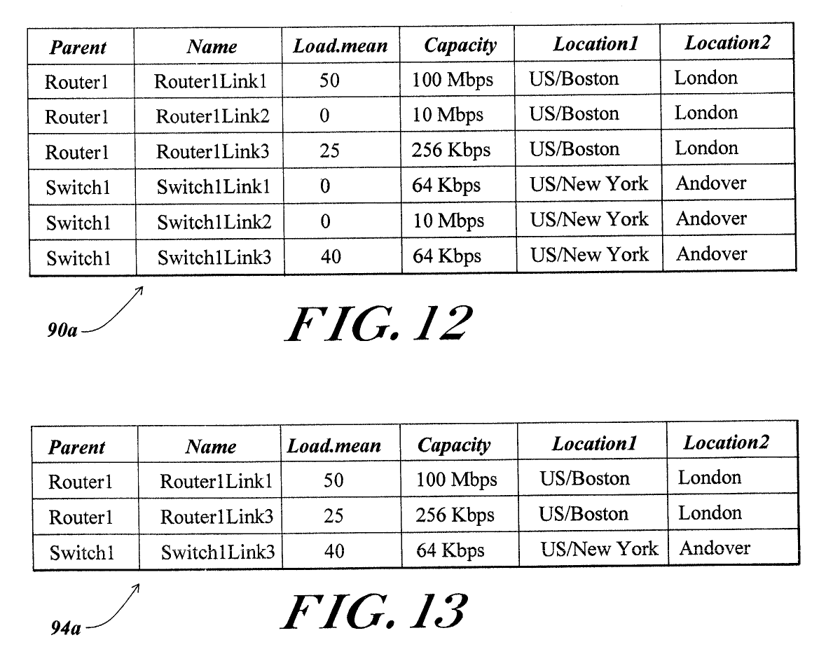

For example, with reference to FIGS. 12 and 13, the user may not be interested in obtaining any information about those links that carry no load. In such a case, the application of a filter, which is designed to retain information relating to only those links that exhibit non-zero traffic load, to the exemplary input dataset 90a results in generating a derived dataset 94a, shown in FIG. 13. An inspection of the filtered dataset 94a shows that it does not contain any information regarding the transmission links with an average load of zero.

Referring again to the flowchart 84 of FIG. 10, the transformations 92 can include one or more computational operations 98 that can be applied to the input dataset 90 and/or the derived dataset 94 to generate a new derived dataset or to modify an existing derived dataset. These computational operations can include, but are not limited to, mathematical computations, textual modifications, or any customized function. Mathematical computations can include, but are not limited to, addition, subtraction, multiplication, division, obtaining absolute values, and rounding off values of selected fields. Some examples of textual modifications include concatanation of strings of characters in two or more fields or records, truncation of a string of characters in a field, conversion of characters to lower or upper cases, and/or generating a list from a plurality of characters.

By way of example, the following computational operations can be applied to the exemplary derived data set 94a, obtained by applying a filter to the input dataset 90 as described above, in order to compute a quantity, herein referred to as Volume and defined as the number of bytes flowing through a link in a day, and another quantity, herein referred to as Daily_capacity and defined as the total number of bytes that can pass through a link in a day, of various transmission links:

Volume=load.mean*capacity/100.0*24/8.0*3600

Daily_capacity=capacity*3600*24/8.0

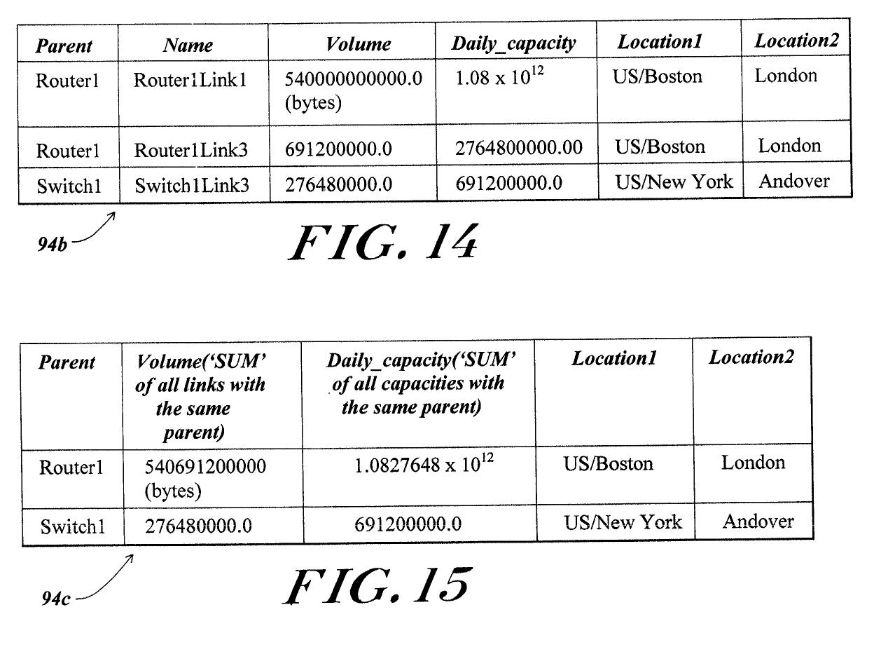

More particularly, the application of the above formulas to the derived dataset 94a results in creation of another derived dataset 94b, shown in FIG. 14, which lists the Volume and Daily capacity for various links and devices associated with those links. Computational operations other than those described above can also be applied to an input and/or derived dataset. For example, data fields in a dataset can be re-ordered in accordance with a pre-defined ordering scheme.

Referring again to FIG. 10, another transformation that can be applied to an input data set and/or a derived data set is summarizing the dataset, in step 100, along a particular dimension, e.g., time, geography, device type, vendor. For example, data contained in the illustrative data set 94b (FIG. 14) can be summarized to obtain another derived dataset 94c (FIG. 15) which contains information regarding the aggregate Volume and Daily_capacity of each device. That is, the Volume and Daily_capacity associated with all those links which are supported by a device can be combined to obtain the total Volume and Daily_capacity of that device. More specifically, the exemplary derived dataset 94c includes data relating to the total Volume and the Daily_capacity for Router1 and Switch1.

In another example, device outage data contained in a dataset can be summarized to show outage data for devices supplied by a particular vendor. Alternatively, such outage data can be summarized to depict the outage by device type. In yet another example, a summary of the outage data that shows the number of outages for a device can be obtained. Those skilled in the art will appreciate that obtaining a summary of a dataset is not limited to the examples provided above. In particular, a dataset can be summarized in accord with the teachings of the invention with respect to any chosen parameter.

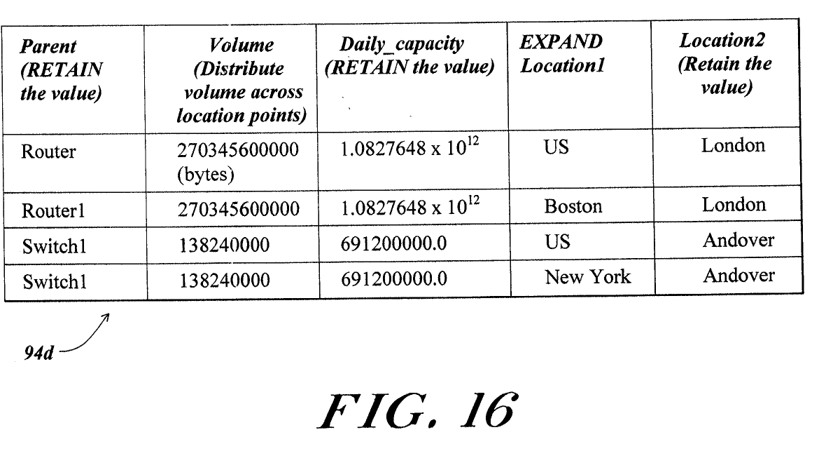

Referring again to FIG. 10, in addition to the transformations described above, in step 102, the data contained in the input data set 90 and/or the derived dataset 94 can be expanded with respect to one or more parameters. For example, the dataset 94c can be expanded with respect to parameter ‘Location 1’ to generate a new derived dataset 94d, shown in FIG. 16. In this example, the field “US/Boston” is expanded to [“US”, “Boston”] and the field “US/New York” is expanded to [“US”, “New York”]. This expansion is herein referred to as a “LIST” expansion. When expanding a dataset with respect to a field to generate new records, the user can specify how the remaining fields are to be distributed among the new records. For example, the user can choose to retain the values of the remaining fields as those before applying the expansion. Alternatively, the user may choose to distribute the values, e.g., equally, along the length of the expansion. For instance, if the expansion leads to creation of 3 new rows of data, the value of a field can be retained as it was before the expansion in each row, or it can be distributed equally in each row.

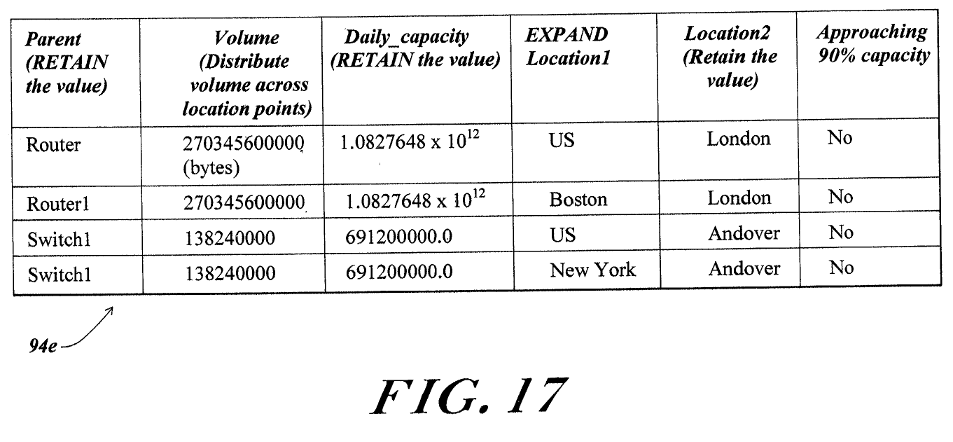

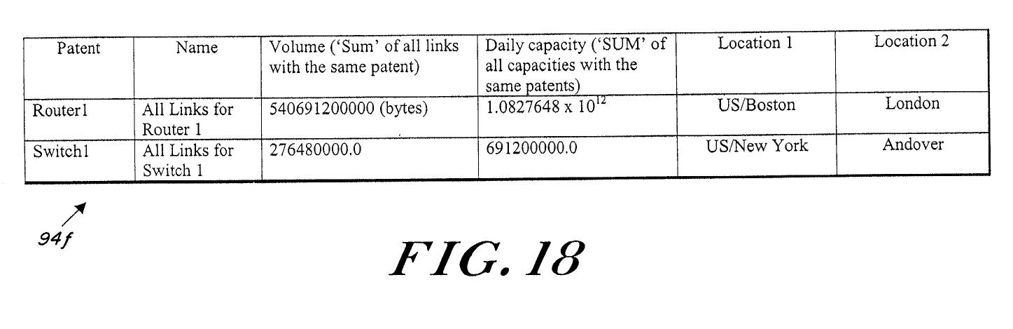

In an alternative expansion procedure, herein referred to as “Location_List” expansion, the field “US/Boston” can be expanded as [“US”, “US/Boston”]. Those skilled in the art will appreciate that the expansion procedures that can be implemented by the methods and system of the invention are not limited to those described above. In particular, a dataset can be expanded in accord with the teachings of the invention with respect to any field and by utilizing any criteria desired by the user. Further, the invention allows a user to create new data fields by defining one or more custom defined formulae. For example, new data fields can be added to the exemplary data set 94d (FIG. 16) to generate another data set 94e, shown in FIG. 17. The new data fields indicate whether the volume of traffic carried by a link is approaching approximately 90% of the link capacity.

Other custom defined transformations can also be applied to the derived data set 94. By way of example, a custom-defined transformation can be applied to the exemplary derived dataset 94c (FIG. 15) to add a name field with descriptions “All links for Routerl” and “All links for Switch1” associated with Router1 and Switch1, respectively, thereby generating another transformed dataset 94f, shown in FIG. 18. These new descriptions more clearly indicate the type of information that the variables Volume and Daily_capacity are intended to provide.

Referring again to FIG. 10, multiple iterative transformations can be applied to the derived dataset 94. For example, after applying a filter to an input dataset to generate a derived dataset, an expansion procedure and/or one or more computational operations can be applied to the derived dataset to create a new derived dataset. This new derived data set can be presented to a user, as discussed in more detail below. Alternatively, it can be utilized as an input dataset into one or more other transformations.

With continued reference to FIG. 10, in step 104, the method of the invention allows presenting the derived dataset 94 in a selected presentation format. In other words, the derived dataset can be employed to generate reports based on different presentation formats. For example, the derived dataset 94 can be presented in an HTML, a CSV, or an XML format. Further, a user can employ a variety of graphical tools, provided by a system of the invention, for presentation of the derived dataset. For example, the information regarding traffic volume contained in the above exemplary derived dataset 94c (FIG. 15) can be presented as an X-Y chart with the device name as the X-label and Volume as the Y-label.

In another aspect, a method of the invention for shaping data can provide an alert, e.g., in the form of an e-mail, to a user based on one or more conditions. For example, an alert can be generated if the calculated Volume in the above exemplary dataset 94c of FIG. 15 falls below a selected threshold.

Further, the method of the invention can be optionally utilized to periodically and automatically generate reports by utilizing information contained in one or more datasets, as discussed in more detail below. In this manner, the invention provides an integrated data management and analysis environment that can be utilized in an automated fashion to serve the informational needs of a user.

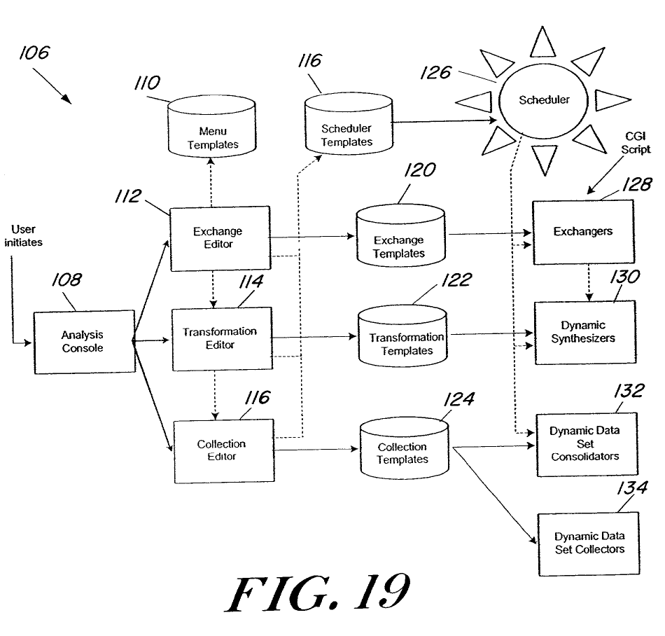

The data shaping transformations described above can be implemented by utilizing a shaping transform module, such as the module 62 of the system 54 in FIG. 8, which can have an exemplary system architecture 106, shown in FIG. 19. The system 106 provides a user with the ability to initiate generation and to control processing of reports. A user may define the time periods in which each transformation is produced, and may also define the types of exchanges, e.g., HTML, XML, CSV, and their generation policy. A user may also add or remove HTML exchanges from the menu templates 110, and manually initiate testing of transformations and exchanges. The system 106 provides a reporting mechanism that serves as a foundation for the generation of reports regardless of the type of data.

Specifically, an analysis console 108, which can include a graphical user-interface allows users to select one or more editors, e.g., exchange editor 112, transformation editor 114, and/or collection editor 116 to update or modify system parameters. The analysis console 108 can preferably include a menu system that allows a user to access, organize, add, or remove HTML exchanges, i.e., reports. The menu system can include a menu hierarchy which can be reorganized by the user.

By way of non-limiting example, a user can add reports to the menu by specifying: 1) the path for the report, e.g., CapacityView/Device Reports, 2) the report 's order within a particular group, e.g., first, after another specified report, 3) the background image to be used for the particular menu item, and 4) the text to overlay on the background image, if any.

In some embodiments, when a report is deleted, it is automatically removed from the menu. However, the system 106 can be configured to allow removing a report from the menu without the need to delete the report from the system, thereby providing further flexibility in customizing the menu system.

The menu system further allows a user to readily edit the hierarchy of the report menus. By way of example, a particular report can be moved from one menu level to another. In addition, the order of reports residing at a particular menu level can be rearranged. Even menu levels themselves, can be reorganized by adding new top-level menus, or by adding and removing items at any level in the hierarchy. Further, the overall menu hierarchy can be reorganized by a user.

All three editors 112, 114, and 116 can be utilized to modify the menu templates 110 and scheduler templates 118. A scheduler 126 can utilize the scheduler templates 118 to automatically and periodically generate specified exchanges 128, transformation 130, or dataset consolidators 132. In addition, each editor 112, 114, and 116 can modify its own respective templates, namely, the items 120, 122, 124.

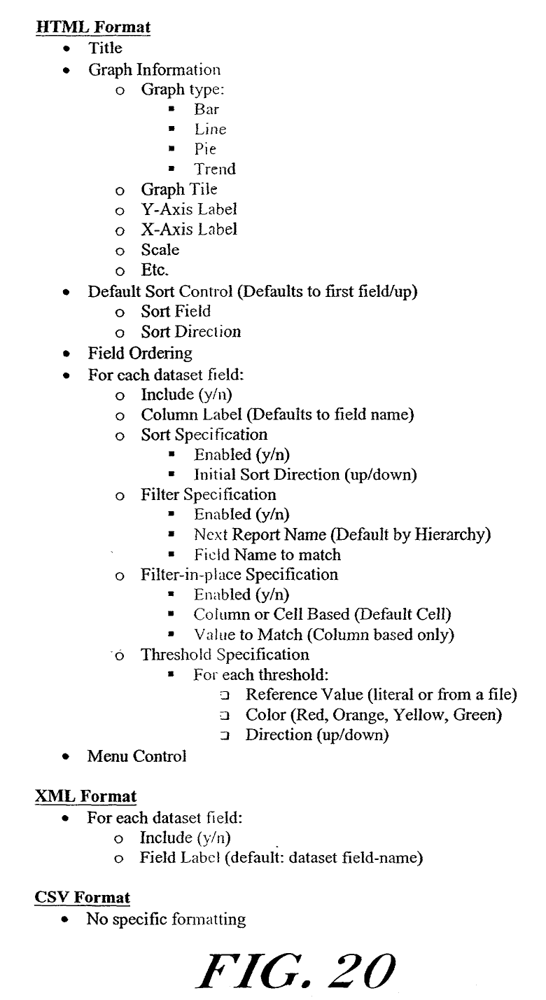

The exchange editor 112 allows a user to define and modify formatting operations that are performed on a particular dataset. The formatting operations and modifications thereto can be stored in exchange templates 120. The exchange editor 112 allows a user to access the exchange templates 120, and select datasets, e.g., from a list, upon which one or more formatting operations are to be performed. In addition to a list of datasets, each exchange template 120 can specify the format of a report to be created (e.g. HTML, XML, CSV), and the corresponding format-type specific information (See FIG. 20). This process provides the user with flexibility and control over the report content and format.

In some embodiments, when a new dataset is required for a particular formatting operation, the exchange editor 112 automatically invokes the transformation editor 114 to create the dataset. Further, the exchange editor 112 offers a user the option to add HTML exchanges, i.e., reports, to the report menu. If the user selects this option, the exchange editor 112 automatically updates the menu template 110 accordingly.

The system 106 also allows a user to schedule exchanges (reports) on a periodic basis, e.g., daily, weekly, monthly, yearly. For any defined period, a user can select various scheduling options, e.g., “never”, “on-demand”, “automatic”. If the “automatic” option is chosen, the exchange editor 112 will automatically update the scheduler template 118 with the new schedule data and the scheduler 126 will initiate the exchanger processa 128 at the selected times. If an exchange is deleted, then all its scheduling information is removed from the corresponding template 120.

For example, a network administrator may be interested in a monthly report depicting throughput, and daily capacity of a particular network device. Such a report can be generated on a monthly basis by simply selecting “monthly” and “automatic” as scheduling options. Upon such selection, the exchange editor 112 updates the scheduler template 118, and the scheduler 126 launches the exchanger 128 on a monthly basis to generate the report.

The “on-demand” scheduling option can be the default parameter for the exchange scheduling so as to generate exchanges, when selected, based on user request only. A user can also retain a particular exchange in a disabled state by simply selecting “never” as the scheduling option. Building on the example above, to change the scheduling option to “ondemand” or “never”, a network administrator need only utilize the exchange editor 112 to modify the options in the scheduler template 118.

The transformation editor 114 allows a user to define new transformations and to modify existing transformations. The transformation templates 122 are then updated to reflect any changes and/or additions made. The transformation editor 114 allows a user to specify the base datasets that are to be used as input for the transformation.

In some embodiments, when a new dataset needs to be collected, the transformation editor 114 automatically invokes the collection editor 116 to define the dataset. As with exchanges, transformations can also be scheduled on a periodic basis, e.g., daily, weekly, monthly, yearly. For any defined period, a user can also select the same scheduling options as those described above, e.g., “never”, “on-demand”, “automatic”.

The “automatic” option can be the transformation scheduling default. In such a case, when the “automatic” option is selected, it automatically updates the scheduler template 118 with the new schedule data to cause the scheduler 126 to run the transformation at the selected times. The “never” and “on-demand” transformation scheduling options operate in a manner similar to the exchange process described above. If a particular transformation is deleted, then all the corresponding scheduling information is removed from the scheduler templates 118.

The collection editor 116 defines the rules for dynamic data set collectors 134 and dynamic data set consolidators consolidating 132 . Specifically, it allows new base datasets to be defined by a user along with the rules for their collection. The collection editor 116 can produce and modify collection templates 124 that define which dataset consolidators 132 should be created.

The collection editor 116, as with the exchange 112 and transformation 114 editors, can update the scheduler template 118, which then invokes the scheduler 126 to periodically generate dataset consolidators 132. The collection templates 124 also contain the collection rules for use by the dataset collectors 134.

Exchanger processes 128 can be initiated periodically by the scheduler 126 as discussed above, or by an external source such as a CGI script. Also, a built-in test capability allows a user to run a given exchange, and view the result to verify that it is correctly specified. If a derived dataset is needed by an exchanger process 128 and it has not been produced at the time the formatting operation is run, the exchanger 128 will invoke the appropriate synthesizer 130 to generate the dataset.

This feature provides a run-time capability analogous to the off-line user-driven process. Specifically, as discussed above, a user can utilize the exchange editor 112 to generate or modify a report by utilizing appropriate pre-existing datasets. If the datasets do not exist, then the transformation editor 114 followed by the collection editor 116 are invoked to generate the appropriate datasets. However, when the report is requested automatically by the scheduler 126 or by a CGI script, and the datasets do not exist, then the dynamic synthesizer 130 is invoked to create the new datasets.

The various modules of a system of the invention can be created by utilizing well-known software design and implementation practices. Various programming languages, such as C++, Java, or other object-oriented or structured languages, can be utilized for generating software modules corresponding to the modules described above. In addition, a system of the invention can have a distributed architecture in which various modules interact with one another and the data repositories, i.e., databases, via a network, e.g., the Internet.

The above embodiments are presented for illustrative purposes only. Those skilled in the art will appreciate that various modifications can be made to these embodiments without departing from the scope of the present invention. For example, policies other than those described in the above examples can be defined and implemented by a system of the invention. Further, the formatting transformations are not limited to those described above.

What is claimed is:

1. In a database system, a method for organizing information in a dataset, the method comprising the steps of:
defining a set of rules that establish a policy, and
generating at least one label based on said defined policy for tagging said dataset,
wherein said policy determines a data scope accessible to said label.

2. The method of claim 1, wherein said policy is based on a structure of an organization.

3. The method of claim 1, wherein said policy is based on geography.

4. The method of claim 1, wherein said policy is based on location of selected entities.

5. The method of claim 1, wherein said policy is based on names of selected entities.

6. The method of claim 1, wherein said policy is based on interrelationships of selected entities.

7. The method of claim 1, wherein said policy defines a range of IP addresses for a plurality of devices.

8. The method of claim 1, wherein said dataset includes a plurality of fields and said rules are defined as expressions operating on selected fields of said dataset.

9. The method of claim 8, wherein said expressions are Boolean expressions.

10. The method of claim 8, wherein said expressions are regular expressions.

11. The method of claim 8, wherein the policy includes matching a selected pattern with fields of the dataset.

12. The method of claim 1, wherein said step of generating further includes creating a plurality of labels interrelated by a selected topology.

13. The method of claim 1, wherein said topology is selected to be a distributed configuration.

14. The method of claim 1, wherein said step of generating further includes creating a plurality of labels forming a hierarchy.

15. The method of claim 14, wherein said hierarchy has a tree structure.

16. The method of claim 14, wherein each of said labels provides an entry point into said hierarchy.

17. The method of claim 1, wherein said dataset includes a plurality of fields and said generating step includes tagging at least one field of said dataset with a label indicating association of said field with at least one scope determined by said policy.

18. The method of claim 16, wherein a role of a user of said database system determines an entry point for said user into said hierarchy.

19. The method of claim 1, wherein at least a portion of data within the scope of said label is accessible to a user based on the user's pre-defined role and permission granted to said user.

20. The method of claim 13, wherein the data scope of each label is independent of the data scope of another label.

21. The method of claim 14, wherein said label in said hierarchy contains datasets that are independent of the hierarchy and are related to a role of a user.

22. The method of claim 1, further comprising the step of transforming said data scope based on a role of a user to provide a derived data set suitable for informational needs of the user.

23. The method of claim 22, wherein said step of transforming preserves association of the derived dataset with said label.

24. The method of claim 1, further comprising the step of generating a role access list containing information regarding at least a role that a user of said database system can assume, wherein said role determines whether said user has access to the data scope associated with said label.

25. The method of claim 24, further comprising the step of allowing a user to assume different roles.

26. The method of claim 22, wherein said transforming step includes a temporal transformation that aggregates selected fields within said data scope over a specified time period.

27. The method of claim 22, further comprising the step of formatting said derived data set to augment said derived data set with information needed for a selected presentation format.

28. The method of claim 27, wherein said presentation format is selected from the group consisting of HTML, XML, CSV, RDBMS and PDF.

29. The method of claim 1, wherein said policy is defined by an administrator of said system.

30. In a network management system, a method for processing raw data, comprising the steps of:
scoping said raw data by extracting a plurality of subsets of said raw data to create a data span based on a pre-defined policy, and
shaping said data span to create a derived data set in accord with a role of a specific user.

31. The method of claim 30, wherein said spanning policy is defined by an administrator of said network management system.

32. The method of claim 30, further comprising the step of formatting said derived data set to augment said derived data set with information needed for a selected presentation format.

33. The method of claim 32, wherein said presentation format is selected from a group consisting of HTML, XML, CSV, RDBMS and PDF.

34. The method of claim 30, wherein said rules are defined to scope said raw data based on a structure of an organization utilizing said network management system.

35. The method of claim 30, wherein said rules scope said raw data based on interrelationships of selected entities.

36. The method of claim 35, wherein said interrelationships form a hierarchy.

37. The method of claim 30, wherein said shaping step is selected to include a temporal transformation that aggregates said plurality of subsets over a specified time period.

38. The method of claim 30, wherein said policy rules are defined such that said scoping step creates a data span including a structural interrelationship of at least partially overlapping subsets of data.

39. The method of claim 30, further comprising the step of allowing a user of said network management system to assume different roles.

40. The method of claim 30, wherein said scoping step includes tagging fields of said raw data with labels indicating association of each field with at least one scope defined by said policy.

41. In a database system, a method for shaping information in a dataset, the method comprising the steps of:
selecting one or more fields in the dataset,
transforming said selected fields based on a pre-defined set of one or more operations to generate an intermediate dataset,
generating a derived dataset from said intermediate dataset by performing any of the following steps:
(a) summarizing the information contained in said transformed fields,
(b) reordering the transformed fields.

42. The method of claim 41, wherein the step of generating a derived dataset further includes expanding the information contained in said transformed fields.

43. The method of claim 41, wherein the step of selecting one or more fields further comprises utilizing a filter to extract the selected fields from the dataset.

44. The method of claim 41, wherein the pre-defined set of one or more operations includes at least one arithmetic function.

45. The method of claim 41, wherein the pre-defined set of one or more operations includes applying at least one statistical function to said selected fields.

46. The method of claim 41, wherein the pre-defined set of one or more operations includes at least one string function.

47. The method of claim 44, wherein the arithmetic function is selected to be any of addition, subtraction, multiplication, division, rounding, and absolute value determination.

48. The method of claim 45, wherein the statistical function is selected to be determining any of mean value, median value, nth percentile value, forward weighted mean value of said selected fields.

49. The method of claim 46, wherein the string function is selected to be any of concatenation, slicing, truncation, conversion to lower case, conversion to upper case, split by separator into a list, and translation through a designated mapping table.

50. The method of claim 41, wherein the summarizing step further comprises creating a record based on a pre-defined combination of said transformed fields.

51. The method of claim 41, wherein the summarizing step further comprises aggregating said transformed fields over a specified time period.

52. The method of claim 1, further comprising generating a report by utilizing the derived dataset.

53. The method of claim 12, wherein the step of generating a report further comprises formatting the derived dataset in accord with a selected presentation format.

54. The method of claim 13, wherein the presentation format is any of HTML, XML, CVS, RDBMS, and PDF.

55. The method of claim 52, wherein the step of generating a report further comprises automatically scheduling generating the report at pre-defined time intervals.

56. The method of claim 41, further comprising monitoring at least one field in the derived data set and alerting a user if a value of the monitored field conforms with a pre-determined criterion.

57. The method of claim 56, wherein the step of alerting a user further includes alerting the user if the value of the monitored field exceeds a pre-determined threshold.

58. The method of claim 56, wherein the step of alerting a user further includes alerting the user if the value of the monitored field is below a pre-determined threshold.

59. A system for organizing data in a database, comprising:
a scope transform module in communication with a database, said scope transform module receiving raw data from said database and labeling at least a portion of said raw data based on a pre-defined policy, and
a shaping transform module receiving said labeled data and transforming at least a portion of said labeled data to a derived dataset that conforms to informational needs of a user.

60. The system of claim 59, further comprising
a format transform module that receives the derived dataset and augments the derived dataset with information needed for a selected presentation format.

61. The system of claim 60, wherein said presentation format is selected from the group consisting of HTML, XML, PDF, CSV, and RDBMS.

62. The system of claim 60, further comprising a presentation engine for presenting said formatted dataset to a user.

63. The system of claim 62, wherein said presentation engine is a web browser.

64. The system of claim 59, further comprising a graphical user interface (GUI) to allow a user to interact with any of the scope transform module and the shaping transform module.

65. The system of claim 64, wherein the graphical user interface includes a menu hierarchy.

66. The system of claim 65, wherein the menu hierarchy presents to a user a list of reports from which the user can select one or more reports to be generated.

67. The system of claim 64, wherein the format transform module includes an exchange editor in communication with the GUI to receive instructions from a user for elective formatting of the derived dataset.

68. The system of claim 67, wherein the shaping transform module includes a transformation editor in communication with the exchange editor and the graphical user interface, said transformation editor effecting transformation of at least a portion of the labeled data to generate the derived dataset.

69. The system of claim 68, wherein the scope transform module further includes a collection editor in communication with the transformation editor and the exchange editor for collecting raw data from a database and providing the transformation editor with a labeled dataset.
